(19) United States
(12) Patent Application Publication
(10) Pub. No.: US 2014/0313577 A1
(43) Pub. Date: Oct. 23, 2014

(54) METHOD FOR ILLUMINATING AN OBJECT IN A DIGITAL LIGHT MICROSCOPE, DIGITAL LIGHT MICROSCOPE AND BRIGHT FIELD REFLECTED-LIGHT ILLUMINATION DEVICE FOR A DIGITAL LIGHT MICROSCOPE

(71) Applicant: Carl Zeiss Microscopy GmbH, Jena (DE)

(72) Inventors: Hans TANDLER, Jena (DE); Johannes KNOBLICH, Jena (DE); Dominik STEHR, Jena (DE); Alexander GAIDUK, Jena (DE); Enrico GEIßLER, Jena (DE); Jan BUCHHEISTER, Jena (DE); Max FUNCK, Weimar (DE)

(73) Assignee: Carl Zeiss Microscopy GmbH, Jena (DE)

(21) Appl. No.: 14/255,707

(22) Filed: Apr. 17, 2014

(30) Foreign Application Priority Data
Apr. 19, 2013 (DE) 10 2013 006 996.3

(51) Int. Cl. G02B 21/12

(52) U.S. Cl. CPC G02B 21/125
USPC 359/387

(57) ABSTRACT

The invention relates to a method for illuminating an object in a digital light microscope, to a digital light microscope, and to a bright field reflected-light illumination device for a digital light microscope. According to the invention, the bright field reflected-light illumination and the dark field reflected-light illumination are configured with light-emitting diodes as light sources and are individually or jointly drivable via a control unit. Both the bright field reflected-light illumination and the dark field reflected-light illumination are configured as “critical” illumination, in which the light source is imaged into the object plane.

The invention relates to a method for illuminating an object in a digital light microscope, to a digital light microscope, and to a coaxial bright field reflected-light illumination device for a digital light microscope.

Various illumination strategies for light microscopy are known from the prior art.

Firstly, a distinction is made between transmitted-light and reflected-light microscopy. Particularly in reflected-light microscopy, the sample is illuminated from the direction of the objective. For this purpose, so-called Köhler illumination has been used for a very long time in order to be able to influence the aperture and the illuminated object diameter independently of one another. In this case, the light, proceeding from a light source, is guided through the luminous field stop into a region in which color and reduction filters can be inserted. Afterward, the light passes through the aperture stop and thereupon impinges on a semitransparent mirror, which deflects the majority of the light in the direction of the objective, which also includes the condenser function. From there, the light is focused onto the object by the objective. The light is reflected from said object, and it passes through the objective again. The light again passes through the semitransparent mirror and is deflected in the direction of the eyepieces or of the image detection system. After passing through the eyepieces, the light impinges on the observer's retina or the sensor of the image detection system.

As an alternative to Köhler illumination, so-called “critical illumination” or Nelson illumination is employed, in which the collector images the image of the light source into the specimen plane. Hitherto this has led to a very irregularly illuminated image field and to a disturbing imaging of the light source in the specimen. In order nevertheless to illuminate the image field more uniformly, ground-glass plates can be inserted between collector and specimen in order to generate a diffuse light. In this case, however, light is lost on account of the diffusion by the ground-glass plates.

In the prior art, LEDs are increasingly being used as illumination light sources and in this case they are positioned in the previous beam path.

By way of example, WO 2007/111735 describes a microscope for examining biological samples with an LED illumination source using the transmitted-light method, which source is embodied as an LED array. The LEDs can be separately switched and controlled in terms of brightness and color.

EP 2 551 712 A1 discloses an illumination method for a microscope, wherein the sample is examined using transmitted-light bright field illumination or using reflected-light fluorescence illumination, wherein a white-light LED is used as light source for the transmitted-light bright field illumination and, in the case of reflected-light fluorescence illumination, a shutter is switched on at a location of the illumination beam path of the transmitted-light bright field illumination.

JP 2010-204531 A describes a zoom microscope comprising an optical illumination system comprising an LED light source.

JP 2010-156939 A discloses a microscope comprising an LED illumination unit that is improved by optical measures.

JP 2010072503 A discloses an illumination controller for an LED illumination device of a microscope, in which device LED modules with stored characteristics are exchangeable.

JP 2009 063856 A describes an objective with a ring-shaped LED dark field illumination unit. Said objective can be used with a bright field microscope.

WO 2008/073728 A1 discloses a microscope comprising an LED illumination device, which constitutes a Köhler illumination.

DE 10 2006 016 358 A1 describes a portable travel microscope having an efficient LED illumination.

On account of the multiplicity of optical components in the illumination beam path of the Köhler illumination, the efficiency of the illumination, particularly in the case of bright field illumination, is often less than satisfactory despite the use of LEDs. This is critical in digital microscopy, in particular, since here the images from the sensor have to be processed and displayed almost in real time and a high light intensity increases the image rate.

Therefore, the invention addresses the problem, in the case of a digital microscope, of enabling a uniform and highly efficient illumination of the object to be observed both in the coaxial reflected-light bright field and in the reflected-light dark field with the aim of maintaining the sought illumination parameters from the object as far as the image capture sensor and of achieving a high image rate of up to 30 images/s. Moreover, expedient prerequisites for contrast variations are intended already to be provided with the illumination of the object.

The problem is solved by means of a method for illuminating an object in a digital light microscope according to claim 1, by means of a digital light microscope comprising the features of claim 4, and by means of a bright field reflected-light illumination device comprising the features of claim 5.

The advantages of the invention can be seen, in particular, in the fact that in a digital light microscope an optimum illumination for various applications (bright field, dark field and combination thereof) is possible in an efficient, cost-effective and space-saving manner.

In a method according to the invention for illuminating an object in a digital microscope, a bright field reflected-light illumination and a dark field reflected-light illumination of the object are made possible and combined with one another in an extremely efficient manner. In this case, light-emitting diodes are used for both types of illumination. Semiconductor light-emitting diodes, in particular, are available in many different embodiments and designs and therefore used in preferred embodiments of the invention.

By way of example, high-power light-emitting diodes, light-emitting diode dies (chips), SMD light-emitting diodes or others can be chosen. The person skilled in the art can choose the correct light-emitting diode for the application from a large number of technological variants. Organic light-emitting diodes, too, can be used very advantageously in alternative embodiments of the invention.

In particular, expedient prerequisites for contrast variations and fast image gathering in digital microscopy are provided as a result of the choice of the light sources and the correct combination of the types of illumination.

LED chips having a rectangular cross section are used particularly efficiently, the aspect ratio of said chips corresponding to that of the image detection sensor. As a result, the object field is illuminated such that no extraneous light occurs outside the image capture region.

Bright field illumination and dark field illumination can be operated separately or in combination depending on the application. Variations of brightness, color and/or azimuth are possible both in the case of bright field illumination and in the case of dark field illumination.

If, by way of example, the light-emitting diodes of the dark field illumination are switched successively, that is to say with a changing azimuth, then the detected images can be used to obtain 3D information and calculate surface topographies.

Furthermore, the short switching times of the LEDs make it possible to switch flashlight or stroboscope modes with which rapidly moving objects can advantageously be represented.

A digital light microscope according to the invention comprises at least an objective, a bright field reflected-light illumination device, a ring-shaped dark field reflected-light illumination device, which are operated in each case with light-emitting diodes, with white-light LEDs in one preferred embodiment, and a control unit for simultaneously or separately driving the bright field and dark field reflected-light illumination devices.

In this case, according to the invention, both illumination devices are configured as so-called “critical” illumination or Nelson illumination, in which the light source is imaged into the object plane. By virtue of the illumination optical system which is constructed very efficiently with regard to luminous efficiency and costs, said illumination optical system can be designed in an extremely space-saving manner and is optimally adaptable to the sensor to be used.

The “critical” illumination can be embodied with light-emitting diodes because the latter have a smaller depth extent and better homogeneity than halogen luminaires used hitherto for this type of illumination. Moreover, they have a very good luminous efficiency. On account of the expedient properties of the LED (in particular in the case of a rectangular LED), in the beam path, instead of a complex optical system, a comparatively moderate homogenizer suffices for achieving a very homogeneous illumination of the object.

The homogenizer can be a light mixing rod, for example, which, in one preferred embodiment, also performs a corresponding deflection of the light beam into the beam path of the objective, as a result of which the deflection mirror can be omitted. In this case, the light mixing rod can advantageously be embodied as a hollow-waveguiding light mixing rod having an extremely short structural length, since the demand on the homogenization as a result of adaption of the critical illumination of LED after entry in hollow integrator is low (ratio of x:y extent of source˜x:y extent of mixing rod˜x:y extent of object field). There is no need to eliminate any inhomogeneities as a result of disadvantageous filling of the mixing rod entrance, only inhomogeneities as a result of bonding wires of the source per se. A solid-waveguiding light mixing rod would have to be given correspondingly longer dimensioning.

The dark field reflected-light illumination device is embodied as an illumination ring for coupling to the objective of the digital light microscope. The illumination ring comprises at least two light-emitting diodes (designated as LED hereinafter) which are arranged preferably diametrically on an illumination ring aligned concentrically with respect to the objective. When more than two light-emitting diodes are used, they are arranged, of course, in a manner distributed over the circumference of the illumination ring. In this case, the diameter of the illumination ring is advantageously not larger than the objective itself, as a result of which the pivotability of the objective in the digital microscope is not impaired.

The illumination ring advantageously comprises an electronic interface for driving the light-emitting diodes via the objective, which must then also have such an interface. A calibration of the LEDs is also carried out via said electronic interface, in order to set identical brightness values for all the LEDs and to store the calibration settings. Such electronic interfaces are known to the person skilled in the art.

The illumination ring can likewise alternatively also be equipped with organic light-emitting diodes, which can be ideally adapted to the sensor format in terms of their areal extent and have a very good homogeneity, such that an optical assembly for moderate homogenization can even be dispensed with.

Partial aspects of the invention are explained in greater detail below with reference to the figures.

In the figures:

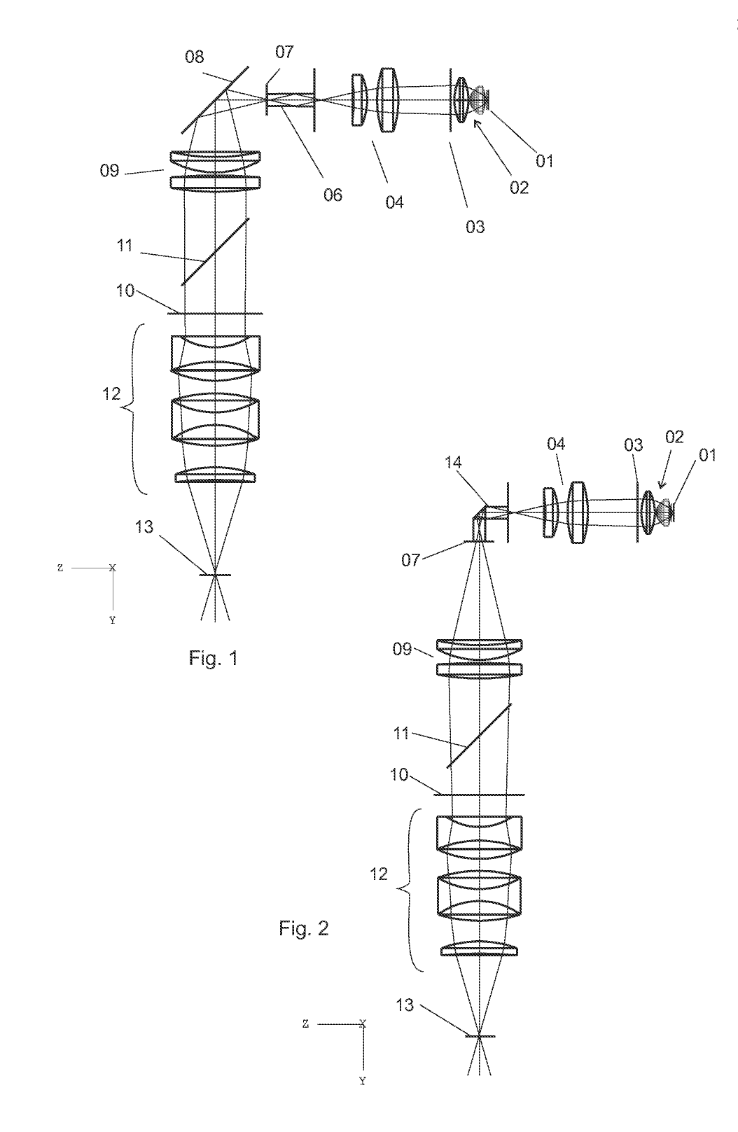

FIG. 1 shows: a first preferred embodiment of a bright field reflected-light illumination device in a basic illustration;

FIG. 2 shows: a second preferred embodiment of the bright field reflected-light illumination device in a basic illustration;

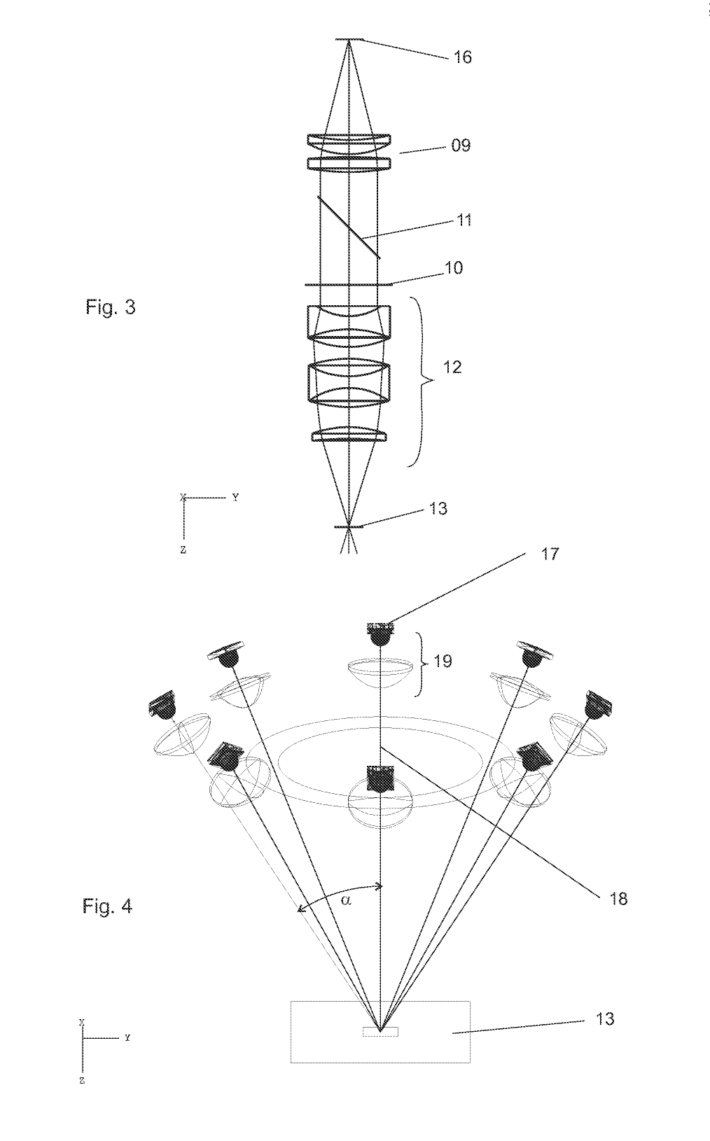

FIG. 3 shows: a third preferred embodiment of the bright field reflected-light illumination device in a basic illustration;

FIG. 4 shows: one preferred embodiment of a dark field illumination device in a perspective basic illustration.

FIG. 1 shows a first preferred embodiment of a bright field reflected-light illumination device according to the invention in a Nelson configuration or so-called “critical” illumination. The device comprises as light source at least one LED 01, equipped with a corresponding optical assembly as collector 02. The light emitted by the LED 01 passes in an illumination beam path through a plane 03 that is conjugate with respect to an aperture stop 10, via an intermediate optical unit 04 into a homogenizer embodied as a light mixing rod 06. In the conjugate plane 03, in an alternative embodiment, a variable second aperture stop can be used in order to be able to set the illumination and observation apertures independently of one another. Contrast enhancements are thus achieved, in particular.

Ideally, an image of the light source, of the emitting LED chip in the embodiment illustrated, arises at the entrance of the homogenizer. However, it can be advantageous to slightly defocus said image in order already to achieve a first blurring of the bonding wires of the light source. In this embodiment, the light mixing rod 06 is a straight hollow-waveguiding rod having a rectangular cross section.

A preferably variable field stop 07 having a rectangular cross section in the format or aspect ratio of the image detection sensor (not illustrated) of the microscope is arranged at the output of the homogenizer 06. By varying the cross section, it is possible for the illumination device to be configured advantageously for different zoom settings of the objective, in order that the size of the object illumination corresponds as far as possible to the size of the image sensor. Even in the event of a change of objective, it is possible to adapt the size of the object illumination with said stop. For the efficiency of the illumination it has proved to be particularly advantageous if the cross section of the light mixing rod 06 and the LED chip also have the format or the aspect ratio of the image detection sensor.

Via a deflection mirror 08, the illumination light is collimated via a further intermediate optical unit 09 and is incident in an objective 12 through the aperture stop 10. The objective 12 generates the image of the variable field stop 07 in the object plane 13.

A plane glass 11 is arranged in the beam path in a known manner in order to feed the detected image to the image detection sensor (not illustrated).

The advantages of this embodiment can be seen, in particular, in the fact that the assembly from the light source as far as the deflection mirror can be embodied in a very compact fashion.

A second preferred embodiment of the bright field reflected-light illumination device is illustrated in FIG. 2. In this case, identical reference numerals denote identical component parts. The embodiment illustrated differs from the embodiment described above in that the homogenizer is fashioned as an angular light mixing element 14. The deflection mirror can advantageously be omitted as a result. This embodiment is even more compact in its design.

In the case of the embodiment illustrated in FIG. 3, instead of a semiconductor LED an OLED 16 (organic light-emitting diode) is used, which has the same format as the image detection sensor. This embodiment is particularly space-saving and efficient since further optical assemblies, such as are otherwise required for bright field illumination, are not necessary. Moreover, OLEDs are inexpensive to produce because they are producible using printing technology, for example. A white-light OLED is preferably used. Alternatively, by means of dichroic splitters, an RGB illumination can be dimensioned or a fluorescence excitation can even be effected by means of monochromatic OLEDs.

FIG. 4 illustrates a basic schematic diagram of an arrangement of LEDs 17 in an illumination ring. The LEDs are inclined at an angle a with respect to an optical axis 19 of the objective (not illustrated), such that the light is mixed, homogenized and focused on the object plane 13 in accordance with the requirements by means of an optical assembly 19.

Here as well, an efficient and space-saving arrangement is achieved by means of a critical illumination, i.e. the light source or light-emitting diode is imaged into the object plane.

For an even better efficiency, it is advantageous to align rectangular LED chips, depending on their position in the illumination ring, in accordance with the rectangular object field form. An even better efficiency is achieved as a result, because only the region actually detected by the image sensor is illuminated.

For a simplified mounting it may be advantageous for the LED chips always to be aligned identically with respect to the concentric ring. As a result, component parts can be embodied identically and the alignment of individual groups is identical. However, that leads to a slight loss of efficiency.

### LIST OF REFERENCE SIGNS

01 LED
02 emission optical unit
03 plane that is conjugate with the aperture stop
04 intermediate optical unit
05 —
06 light mixing rod
07 field stop
08 deflection mirror
09 intermediate optical unit
10 aperture stop
11 plane glass
12 objective
13 object plane
14 light mixing rod, angular
15 —
16 OLED
17 LED
18 optical axis of the objective optical assembly

1. A method for illuminating an object in a digital light microscope,
wherein a bright field reflected-light illumination is effected by means of an illumination device comprising light-emitting diodes (01) as light sources,
wherein a dark field reflected-light illumination is effected by means of a ring illumination device comprising light-emitting diodes (17) as light sources, said ring illumination device being mechanically and electrically coupleable to an objective of the light microscope,
wherein the bright field reflected-light illumination and the dark field reflected-light illumination are separately drivable and superimposable and each configured as critical illumination, in which an image of the light source is projected into an object plane.

2. The method according to claim 1, wherein bright field reflected-light illumination and dark field reflected-light illumination are effected by means of white-light LEDs (01, 17).

3. The method according to claim 1,
wherein the ring illumination device is drivable via an electronic interface of the objective, and
wherein individual or all light-emitting diodes (01, 17) are driven.

4. A digital light microscope for examining an object, comprising;
an objective;
a bright field illumination device;
a dark field illumination device; and
a control unit,
wherein the bright field illumination device comprises at least one light-emitting diode (01, 16) as a light source, and the dark field illumination device is embodied as ring illumination comprising at least two light-emitting diodes (17) as light sources and is coupled to the objective via an electronic interface,
wherein the bright field illumination device and the dark field illumination device are individually or simultaneously drivable via the control unit and are configured as critical illumination, in which an image of a light source is projected into an object plane (13).

5. A bright field reflected-light illumination device for a digital light microscope comprising:
at least one light source embodied as light-emitting diode (01, 16),
wherein the at least one light source is configured as critical illumination, in which an image of the light source is projected into an object plane.

6. The bright field reflected-light illumination device according to claim 5,
wherein the light source is a semiconductor white-light LED (01) and a homogenizer is arranged in the beam path of the bright field reflected-light illumination device, a field stop (07) having a rectangular cross section being provided at the output of said homogenizer, and
wherein the rectangular cross section has the same aspect ratio as an image sensor of the light microscope.

7. The bright field reflected-light illumination device according to claim 6, wherein the homogenizer is a light mixing element.

8. The bright field reflected-light illumination device according to claim 7, wherein the light mixing element realizes a 90° deflection of the light between an entrance opening and an exit opening for the light.

9. The bright field reflected-light illumination device according to claim 6, wherein the homogenizer is a hollow-waveguiding light mixing rod (06, 14) having a rectangular cross section.

10. The bright field reflected-light illumination device according to claim 6, wherein the size of the field stop (07) is variable.
